(19) United States
(12) Patent Application Publication
(10) Pub. No.: US 2007/0258341 A1
(43) Pub. Date: Nov. 8, 2007

(54) Method of adjusting write power in optical drive

(75) Inventor: Che-Sheng Lin, Pan Chiao City (TW)

Correspondence Address: BIRCH STEWART KOLASCH & BIRCH, PO BOX 747, FALLS CHURCH, VA, 22040-0747, US

(73) Assignee: Realtek Semicoductor Corp., Hsinchu (TW)

(21) Appl. No.: 11/790,628

(22) Filed: Apr. 26, 2007

(30) Foreign Application Priority Data
Apr. 27, 2006 (TW) 095115011

(51) Int. Cl. G11B 7/12

(52) U.S. Cl. 369/47.51; 369/53.26

(57) ABSTRACT

A method of adjusting write power in an optical drive system is disclosed. During the writing process, the invention monitors symmetry or β values of RF signals in real time to adjust the optimum write power dynamically, therefore maintaining the best quality of the disk writing.

### BACKGROUND OF THE INVENTION

1. Field of the Invention

The invention relates to an optical drive, and more particularly, to a method of adjusting laser power in an optical drive.

2. Description of the Related Art

Before real writing an optical disk (e.g., CDR/RW or DVD+/−/R/RW, etc.), an optical drive, such as a CD RW drive or a DVD RW drive, has to test and adjust a correct amount of optimum laser power, i.e., performing an optimum power calibration (OPC) procedure. Through the OPC procedure, an optimum writing laser power is determined and thus either jitter values of RF data recorded in the optical disk or error rates (such as C1C2 error rates or PIPO error rates) are ideally suppressed, thereby maintaining the best quality of the disk writing.

However, instead of arbitrary locations, a restricted space on which is allowed to perform the OPC procedure is regulated in a corresponding specification for each optical disk. To write-once recordable disks, such as CDR, DVD+R or DVD-R, there is a great possibility that user data is unable to be written correctly may suffer if the OPC procedure has been performed on a data area 120 as shown in FIG. 1. Although rewritable disks, such as CDRW, DVD+RW, DVD-RW or DVD RAM, are allowed to be rewritten, the writing period will be prolonged if the OPC procedure is performed each time the writing process is carried out. Referring to FIG. 1, in spite of the fact that there are multiple specifications for the optical disk 100, a special area of the optical disk 100 is reserved for use and called power calibration area (PCA) in which the OPC procedure is generally performed. The PCA is divided into a lead-in area 110 and a lead-out area 130, located at the inner radius and outer radius of the optical disk 100 respectively.

Common methods defined in the general specifications for the OPC procedure are a β method and a γ method. Hereinafter, the β method will be described briefly while the γ method is not within the scope of this invention.

FIGS. 2A-2C show waveforms of three different RF signals by writing data at three different laser power levels after reading the written data back.

Referring to FIGS. 2A-2C, different laser power levels result in different asymmetric RF signals and it is especially obvious to the RF signals returned from shorter laser pulses (such as 3T). The β method refers to a process that writes test data at several predetermined laser power levels in the PCA and then establishes an optimum write power P_{wo} for the disk based on asymmetry of RF signals. Meanwhile, a β value is defined as: β=(A₁+A₂)/(A₁−A₂), where A₁ is the maximal RF signal and A₂ is the minimal RF signal. As the β value approaches zero, the RF signal has a most-symmetric waveform, i.e., either the jitter value or the error rate being a minimum. As shown in FIG. 2A, |A₁|<|A₂| and β<0 indicate that a write power P in use is less than the optimum write power P_{wo}. By contrast, as shown in FIG. 2B, |A₁≅|A₂ and β≅0 indicate that the write power P in use is approximately equal to the optimum write power P_{wo}. With respect to FIG. 2C, |A₁|>|A₂| and β>0 indicate that the write power P in use is greater than the optimum write power P_{wo}.

FIG. 3 shows a relation between β values and laser powers. FIG. 4 shows a relation of an embedded β₁ value, its neighboring β values and laser powers, where the β₁ value represents an optimum β value for each disk.

Referring to FIG. 3, there are 15 different β values derived from writing the optical disk 100 at 15 different laser power levels. It is obvious that the β values increase as the laser power increases. Therefore, the optimum write power P_{wo} is determined by substituting β≅0 or using the embedded β₁ value. For instance, if the embedded β₁ value falls within the range between β₇ and β₈ (shown in FIG. 4), the equation (β₁−β₇)/(P_{wo}−P_{w7})=(β₈−β₇)/(P_{w8}−P_{w7}) is calculated based on interpolation. Given that a slope S₇=(β₈−β₇)/(P_{w8}−P_{w7}), the optimum write power is expressed as follows: P_{wo}=P_{w7}+(β₁−β₇)/S₇. The description mentioned above is the OPC procedure that is generally performed on recordable disks.

As previously discussed, the conventional β method performs the OPC procedure on the PCA located at either the inner radius or outer radius of the optical disk in order to determine the optimum write power P_{wo}. Besides, from the inner radius to the outer radius of the disk 100, the dye coating is not definitely uniform and servo controls are not consistent. Since recordable disks can be written only once, it is impossible to perform the OPC procedure on the remaining area outside of the PCA and make precise adjustments to the optimum write power level for each location on the disk 100. Thus, it is important to make the best use of limited information retrieved from a specific location on the disk for optimum write power adjustments.

### SUMMARY OF THE INVENTION

In view of the above-mentioned problems, an object of the invention is to provide a method of adjusting write power in an optical drive which monitors symmetry or β values of RF signals in real time so as to determine the optimum write power dynamically.

To achieve the above-mentioned object, the method of adjusting write power in an optical drive, comprising the steps of: performing a power control procedure to obtain an initial optimum write power and a plurality of writing parameters; writing data to a data area of an optical disk according to the initial optimum write power; stopping writing according to the initial optimum write power after a predefined period of time to calculate a current β value corresponding to the written data; determining a current optimum write power according to the writing parameters, the current β value and a predefined β value; and, writing data to the optical disk according to the current optimum write power.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a side view of a conventional optical disk.

FIGS. 2A-2C show waveforms of three different RF signals by writing data at three different laser power levels after reading the written data back.

FIG. 3 shows a relation between β values and laser powers.

FIG. 4 shows a relation among an embedded β₁ value, its neighboring β values and laser power levels.

FIG. 5 shows a relation among the embedded β₁ value, a βₙ value, their neighboring β values and laser power levels while β₁>βₙ.

FIG. 6 shows a relation among the embedded β₁ value, the βₙ value, their neighboring β values and laser power levels while β₁<βₙ.

FIG. 7 is a flow chart illustrating a method of adjusting write power in an optical drive according to an embodiment of the invention.

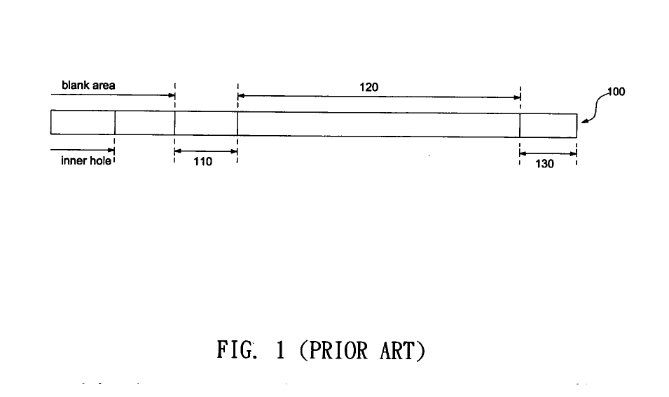

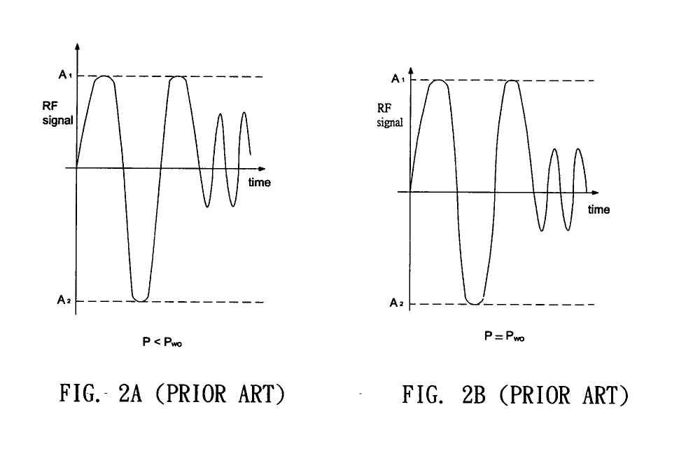

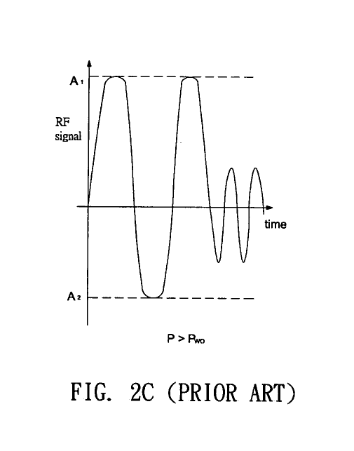

### DETAILED DESCRIPTION OF THE INVENTION

The method of adjusting write power in an optical drive of the invention will be described with reference to the accompanying drawings.

It is unable to perform the OPC procedure on the data area of a recordable disk, so the invention discloses a method that adjusts the optimum write power P_{wo} on-the-fly during the writing process.

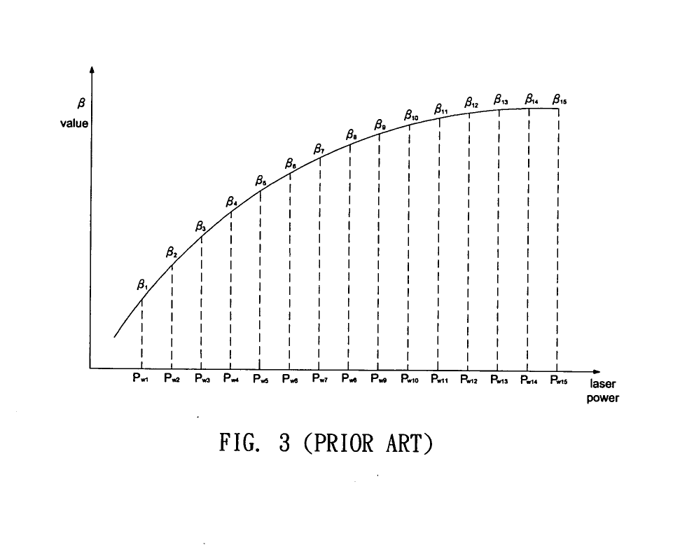

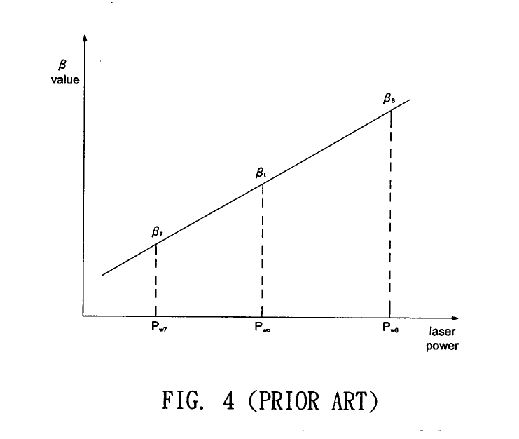

Before starting, an optical drive at first performs the OPC procedure on either the lead-in area 110 or the lead-out area 130. Then, in addition to valid data from β₁ to β₁₅ and from P_{w1} to P_{w15} (taking FIG. 3 as an example), the initial optimum write power P_{wo} is obtained as well based on the embedded or pre-defined β₁ value. Fourteen-segment slopes from S₁ to S₁₄ are accordingly derived and writing parameters (such as a plurality of reference β values from β₁ to β₁₅, a plurality of slopes from S₁ to S₁₄ corresponding to the plurality of reference β values, a plurality of reference write powers from P_{w1} to P_{w15} corresponding to the plurality of reference β values and the initial optimum write power P_{wo}) are finally saved in its memory.

On the other hand, the OPC procedure is allowed to be performed on both the lead-in area 110 and the lead-out area 130 so as to obtain a plurality of inner-radius writing parameters (or a relation curve of inner-radius β value versus laser power) of the lead-in area 110 and a plurality of outer-radius writing parameters (or a relation curve of outer-radius β value versus laser power) of the lead-out area 130. Next, the plurality of writing parameters (inner-radius writing parameters and outer-radius writing parameters) are saved and calculated through interpolation to obtain a set of writing parameters for the whole optical disk. Finally, the initial optimum write power P_{wo} is calculated through interpolation.

While real writing, the optical drive uses the initial optimum write power P_{wo} as a starting point. During writing, although the initial optimum write power P_{wo} remains constant, environmental conditions, such as temperature, dye uniformity or writing speed, may change, thus causing variations to the β value. Therefore, according to the invention, a servo control for writing is stopped either on a suitable occasion or within a predefined period of time (the predefined period of time is either fixed or adjustable as needed). Concurrently, data are read back from the area just written in to calculate a latest βₙ value. Afterward, the βₙ value is compared with reference β values from β₁ to β₁₅ that are saved in the memory so as to determine which range the βₙ value falls into. Next, the slope of the range which the βₙ value falls into is retrieved from the memory and used to calculate a current optimum write power P_{won} through interpolation. The writing process goes on by using the current optimum write power P_{won}.

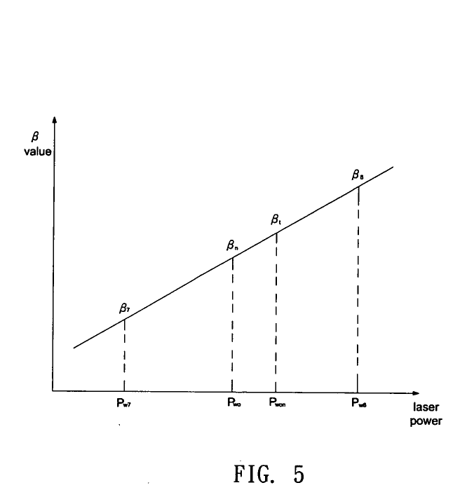

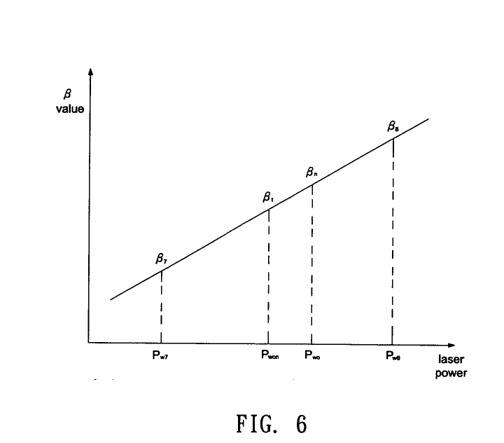

Hereinafter, suppose that both the current βₙ value and the predefined β₁ value fall into a range between β₇ and β₈ (shown in FIG. 5). Two cases show the adjustments to the optimum write power in accordance with FIG. 5 and FIG. 6.

Case 1 is when β₁>βₙ. As shown in FIG. 5, the equation (β₁−βₙ)/(P_{won}−P_{wo})=(β₈−β₇)/(P_{w8}−P_{w7})=S₇ is calculated based on interpolation. If (P_{won}−P_{wo})=(β₁−βₙ)/S₇, a current optimum write power is expressed as follows: P_{won}=P_{wo}+(β₁−βₙ)/S₇, where β₁ is an embedded β value or a predefined β value and P_{wo} is an initial optimum write power.

Case 2 is when β₁<βₙ. As shown in FIG. 6, the equation (βₙ−β₁)/(P_{wo}−P_{won})=(β₈−β₇)/(P_{w8}−P_{w7})=S₇ is calculated based on interpolation. If P_{wo}−P_{won}=(βₙ−β₁)/S₇, the current optimum write power is expressed as follows: P_{won}=P_{wo}+(βₙ−β₁)/S₇.

Consequently, a correct amount of optimum write power for the area just written is determined, regardless of dye non-uniformity and environmental conditions causing asymmetric RF signals, i.e., jitter values and error rates being not minimums.

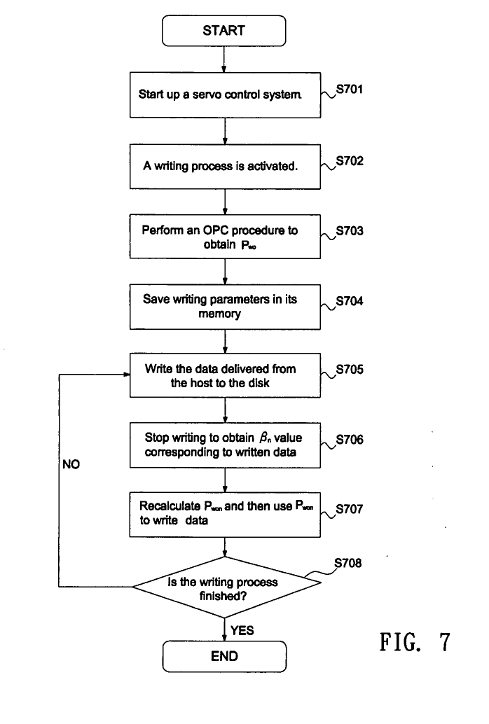

FIG. 7 is a flow chart illustrating a method of adjusting write power in an optical drive according to an embodiment of the invention.

Step S701: While the optical disk 100 is loaded, an optical driver drives a spindle motor to rotate the optical disk 100 and starts up the servo control system.

Step S702: A writing process is activated.

Step S703: The optical disk 100 is searched for an empty PCA in order to perform the OPC procedure; meanwhile, an initial optimum write power P_{wo} is obtained based on a predefined β₁ value.

Step S704: Writing parameters (e.g., reference β values from β₁ to β₁₅, slopes from S₁ to S₁₄, write powers from P_{w1} to P_{w15} and P_{wo}) are saved in its memory.

Step S705: Data delivered from the host begins to be written onto the data area 120 of the optical disk 100.

Step S706: After a predefined of time has elapsed, the writing process stops to obtain a current βₙ value corresponding to the written data. Wherein, the predefined of time is fixed or adjustable.

Step S707: After comparing the βₙ value with β₁ value, the current optimum write power P_{won} is recalculated based on the writing parameters, the βₙ value and β₁ value (referring to two cases as shown in FIG. 5 and FIG. 6). Accordingly, the latest optimum write power P_{won} is used to write data.

Step S708: Determine if the host intends to terminate the writing process. If yes, the writing process is finished, i.e., the data delivered from the host having been completely written into the optical disk 100. Otherwise, the flow returns to step S705 in order to write the data delivered from the host based on the latest optimum write power P_{won}.

The invention not only effectively overcomes the asymmetric RF signal problem caused by either dye non-uniformity or temperature changes between the interior and the exterior of the optical drive, but also has the ability to react by monitoring the writing status in real time, the writing speed and other environmental conditions; accordingly, the current optimum write power P_{won} is then adjusted on-the-fly to render the most symmetric RF signals. Further, since waveforms of the RF signals are monitored closely throughout the writing process, the state of RF signals is truly reflected by dynamically adjusting the current optimum write power P_{won} to continue writing. According to the invention, what is really needed is to save the information after performing the OPC procedure, without additional circuits or extra hardware cost.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method of adjusting write power in an optical drive, comprising the steps of:
performing a power control procedure to obtain an initial optimum write power and a plurality of writing parameters;
writing data to a data area of an optical disk according to the initial optimum write power;
stopping writing according to the initial optimum write power after a predefined period of time to calculate a current β value corresponding to the written data;
determining a current optimum write power according to the writing parameters, the current β value and a predefined β value; and
writing data to the optical disk according to the current optimum write power.

2. The method according to claim 1, wherein the plurality of writing parameters comprises a plurality of reference write powers and a plurality of reference β values respectively corresponding to the plurality of reference write powers.

3. The method according to claim 2, wherein the plurality of writing parameters further comprises a plurality of slopes respectively corresponding to the plurality of reference β values.

4. The method according to claim 2, wherein the step of performing the power control procedure further comprises:
performing the power control procedure respectively on both a lead-in area and a lead-out area of the optical disk so as to obtain a plurality of inner-radius writing parameters and a plurality of outer-radius writing parameters;
determining the plurality of writing parameters by calculating the inner-radius writing parameters and the outer inner-radius writing parameters through interpolation; and
determining the initial optimum write power by calculating the writing parameters through interpolation.

5. The method according to claim 2, wherein the step of determining the current optimum write power further comprises:
obtaining the current optimum write power through interpolation according to the writing parameters, the current β value and the predefined β value.

6. The method according to claim 1, wherein the power control procedure is performed on at least one of both a lead-in area and a lead-out area of the optical disk.

7. The method according to claim 1, wherein the step of performing the power control procedure further comprises:
performing the power control procedure respectively on a lead-in area and a lead-out area of the optical disk so as to obtain a plurality of inner-radius writing parameters and a plurality of outer-radius writing parameters;
determining the plurality of writing parameters through interpolation according to the inner-radius writing parameters and the outer-radius writing parameters; and
determining the initial optimum write power by calculating the writing parameters through interpolation.

8. The method according to claim 1, wherein the step of determining the current optimum write power further comprises:
obtaining the current optimum write power through interpolation according to the writing parameters, the current β value and the predefined β value.

9. The method according to claim 1, wherein the predefined period of time is either fixed or adjustable.
